(19) United States
(12) Patent Application Publication
(10) Pub. No.: US 2006/0136959 A1
(43) Pub. Date: Jun. 22, 2006

(54) Double sided disc tray

(75) Inventor: Chung Fai Cheung, Aberdeen (HK)

Correspondence Address: OSTROLENK FABER GERB & SOFFEN, 1180 AVENUE OF THE AMERICAS, NEW YORK, NY, 100368403, US

(73) Assignee: Forward Electronics Manufacturing Co., Ltd.

(21) Appl. No.: 11/017,153

(22) Filed: Dec. 20, 2004

(51) Int. Cl. G11B 7/085; G11B 21/08; G11B 23/03

(52) U.S. Cl. 720/728

(57) ABSTRACT

A double sided disc storage tray comprises a first tray including a first and a second major side which are parallel to each other, the first major side including a media storage disc fastening means to releasably retain a media storage disc and including engagement means to engage with a complementary engagement means on a second tray, a second tray including a first and a second major side which are parallel to each other, the first major side including a media storage disc fastening means to releasably retain a media storage disc and including engagement means to engage with a complementary engagement means on a first tray, the first and second trays engaged by the complementary engagement means so that the second sides of each tray are adjacent and the first sides of each tray form the outer surface of the double sided disc storage tray.

### FIELD OF THE INVENTION

The present invention relates to a double sided media storage disc tray for storage and presentation of media storage discs, and in particular though not solely to a tray which can be arrayed and joined to other like trays.

### BACKGROUND OF THE INVENTION

Cases for presenting and containing digital media storage discs (“discs”) such as those referred to the in the art as Digital versatile Discs (“DVDs”) or Compact Discs (“CDs”), are known. Such cases are of a book or wallet type design whereby the discs are retained on a central rosette. When multiple discs need to be stored these are located on hinged trays dependent to the inside of the case so that when the case folds open it provides access. Provision to locate graphical and bibliographical information is either on the front or back of the case (or both sites) or in a booklet contained therein.

There is however no way of making use of the external front or back of the case for containing more discs and to easily and scalably arraying such cases together to make a large or multiple discs storage assembly.

### OBJECT OF THE INVENTION

It is therefore an object of the present invention to at least go some way to meeting the shortcomings of the prior art, or to at least go some way to meeting the need for a double-sided disc tray system, or to at least provide the public with a useful choice.

### BRIEF DESCRIPTION OF THE INVENTION

Accordingly there is provided a double sided disc storage tray comprising
a first tray including a first and a second major side which are parallel to each other, the first major side including a media storage disc fastening means to releasably retain a media storage disc and including engagement means to engage with a complementary engagement means on a second tray,
a second tray including a first and a second major side which are parallel to each other, the first major side including a media storage disc fastening means to releasably retain a media storage disc and including engagement means to engage with a complementary engagement means on a first tray,
the first and second trays engaged by the complementary engagement means so that the second sides of each tray are adjacent and the first sides of each tray form the outer surface of the double sided disc storage tray.

Preferably the double sided disc storage tray further comprises an insert card containing information inserted and captured between the second sides of the first and second trays.

Preferably part of each said tray is transparent to allow the insert to be viewed.

In other embodiments each tray is transparent to allow the insert to be viewed.

Preferably the second tray is substantially planar with a skirt formed by shoulders about the tray periphery, depending away from the first side of the tray.

Preferably the first tray is substantially planar with a skirt formed by shoulders about the first tray periphery, depending away from the first side of the tray.

Preferably the first tray skirt engages with the second tray skirt.

Preferably the first and second tray engagement is via complementary detents in one tray skirt, and protrusions in the other tray skirt.

Preferably the second tray skirt includes said detents and the first tray skirt includes said protrusions.

Preferably the first tray includes at least one second shoulder depending from said tray, outside of the first tray skirt that sits flush with the outer surfaces of the second tray skirt when the first and second trays are engaged.

Preferably either the first tray or second tray includes on a vertex thereof provision for engaging a hinge to join two or more double sided disc storage trays into an array.

Preferably the double sided disc storage tray further includes a flexible spine hinge comprising a back plate and a plurality of brackets.

Preferably the double sided disc storage tray further includes a cover comprising a front face substantially the same size as a major side of a tray, a spine and a back face substantially the same size as a major side of a tray.

Preferably the flexible spine hinge retains the cover between the flexible spine hinge and the vertex of the storage tray.

Preferably the first or second tray includes two pairs of receiving apertures for locating and engaging with the flexible spine hinge.

Accordingly there is also provided an array of double sided disc storage trays comprising
a plurality of first trays, each including a first and a second major side which are parallel to each other, the first major side including a media storage disc fastening means to releasably retain a media storage disc and including engagement means to engage with a complementary engagement means on a second tray,
a plurality of second trays, each including a first and a second major side which are parallel to each other, the first major side including a media storage disc fastening means to releasably retain a media storage disc and including engagement means to engage with a complementary engagement means on a first tray,
each first tray engaged to a second tray by the complementary engagement means so that the second sides of each tray are adjacent and the first sides of each tray form the outer surface of the double sided disc storage tray,
and arranging the double sided storage trays to form an array of double sided disc storage trays.

Preferably the array of double sided disc storage trays further comprises insert cards containing information inserted and captured between the second sides of the first and second trays.

Preferably part of each said tray is transparent to allow the insert to be viewed.

Alternatively each tray is transparent to allow the insert to be viewed.

Preferably each second tray is substantially planar with a skirt formed by shoulders about the tray periphery, depending away from the first side of the trays.

Preferably each first tray is substantially planar with a skirt formed by shoulders about the first tray periphery, depending away from the first side of the trays.

Preferably each first tray skirt engages with a second tray skirt.

Preferably the first and second tray engagements are via complementary detents in one tray skirt, and protrusions in the other tray skirt.

Preferably each second tray skirt includes said detents and each first tray skirt includes said protrusions.

Preferably each first tray includes at least one second shoulder depending from said tray, outside of the first tray skirt that sits flush with the outer surfaces of each second tray skirt when the first and second trays are engaged.

Preferably either the first trays or second trays include on a vertex thereof provision for engaging a hinge to join two or more double sided disc storage trays into an array.

Preferably the array further includes at least one flexible spine hinge each comprising a back plate and a plurality of brackets.

Preferably the array further includes a cover comprising a front face substantially the same size as a major side of a tray, a spine and a back face substantially the same size as a major side of a tray.

Preferably the flexible spine hinges retain the cover between the flexible spine hinge and the vertex 5 of the storage trays.

Preferably each first or second tray includes two pairs of receiving apertures for locating and engaging with a flexible spine hinge.

Preferably two of more double sided disc storage trays are retained in a closed form about said flexible spine hinge to form an array.

Preferably all of either the first or second storage trays include at least one magnet, said magnets aligned so as to attract each other and retain the double sided storage trays in an array.

Alternatively all the storage trays include at least one magnet, said magnets aligned so as to attract each other and retain the double sided storage trays in an array.

In one embodiment the array of double sided disc storage trays further includes at least one flexible spine hinge comprising a back plate and a plurality of brackets, and a cover comprising a front face substantially the same size as a major side of a tray, a spine and a back face substantially the same size as a major side of a tray, wherein the flexible spine hinges retain the cover between the flexible spine hinge and the vertexes of the array of double sided disc storage trays.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Preferred embodiments of the present invention will now be described with reference to the accompanying drawings where,

FIG. 1 is a perspective view of a first tray, an insert card and a second tray prior to assembly,

FIG. 2 is a close-up view of the second tray of FIG. 1 showing the location and insertion of magnets,

FIG. 3 is a perspective view of a first tray, an insert card and a second tray where the insert card has been located within the second tray,

FIG. 4 is a close-up view of the complementary engagement means for securing the first tray and second tray together,

FIG. 5 is a cross section through the first tray and second tray showing the engagement of the first tray and the second tray,

FIG. 6 shows the assembled first tray and second tray forming a double faced storage tray,

FIG. 7 is a close-up showing the location of the magnetized means for association of like double face trays when arranged in an array,

FIG. 8 is a perspective view of an array of double faced trays,

FIG. 9 shows the procedure for opening an array of double faced trays of FIG. 8 about a spine,

FIG. 10 is a perspective view of an array of two double faced trays with a cover thereon,

FIG. 11 is a plan view of a first tray,

FIG. 12 is a plan view of the reverse side of the first tray of FIG. 11,

FIG. 13 shows an array of cross-sections of the first tray as shown on FIGS. 11 and 12,

FIG. 14 is a plan view of a second tray,

FIG. 15 is a plan view of the reverse side of the second tray of FIG. 14,

FIG. 16 shows an array of cross-sections through the second tray as shown on FIGS. 14 and 15.

FIG. 17 shows further cross-sectional views as shown of FIGS. 14 and 15,

FIG. 18 is a perspective view showing apertures on the spine of an assembled double faced tray,

FIG. 19 is a perspective view of an array of three double faced trays,

FIG. 20 is a perspective view of a cover that can be associated with the array of double face trays,

FIG. 21 is a perspective view of a flexible spine hinge,

FIG. 22 is a perspective view of the process of assembling a cover, flexible spine hinge, and an array of trays, and

FIG. 23 is a perspective view of a completed assembly of cover, hinge and an array of trays.

### DETAILED DESCRIPTION

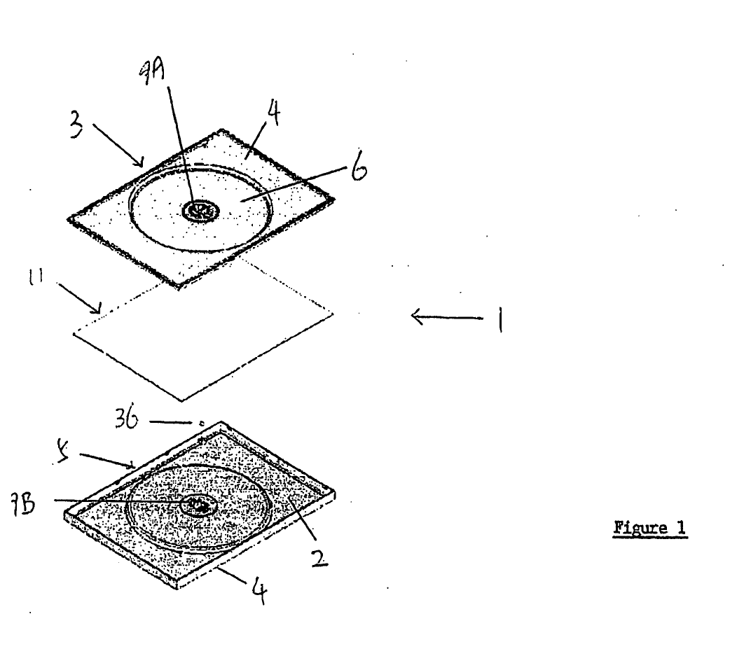

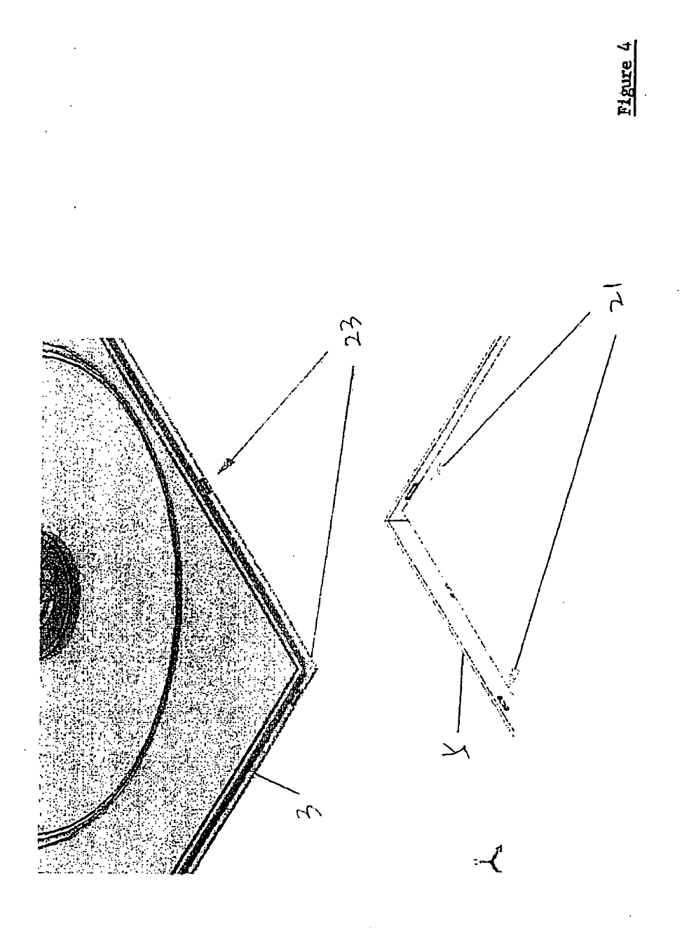

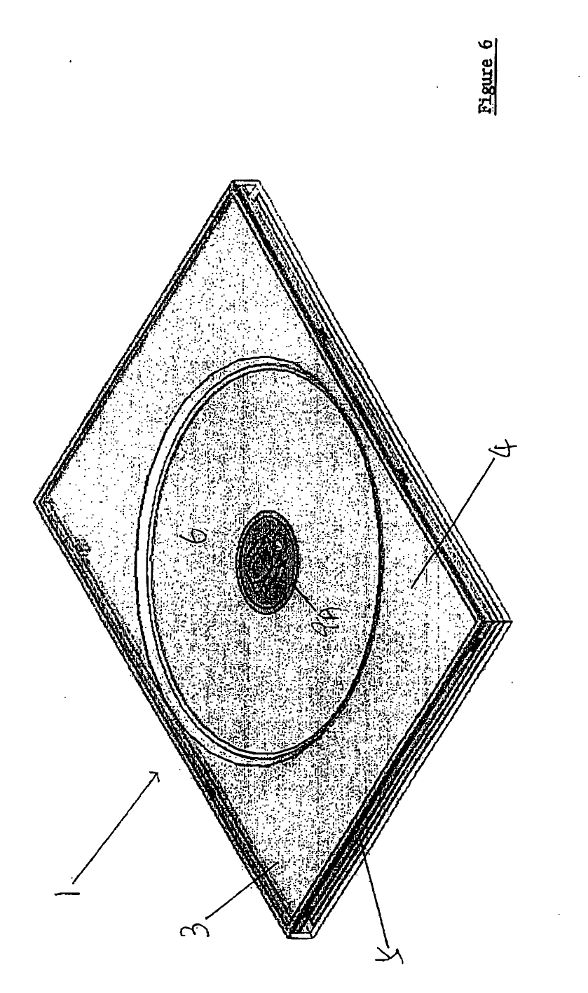

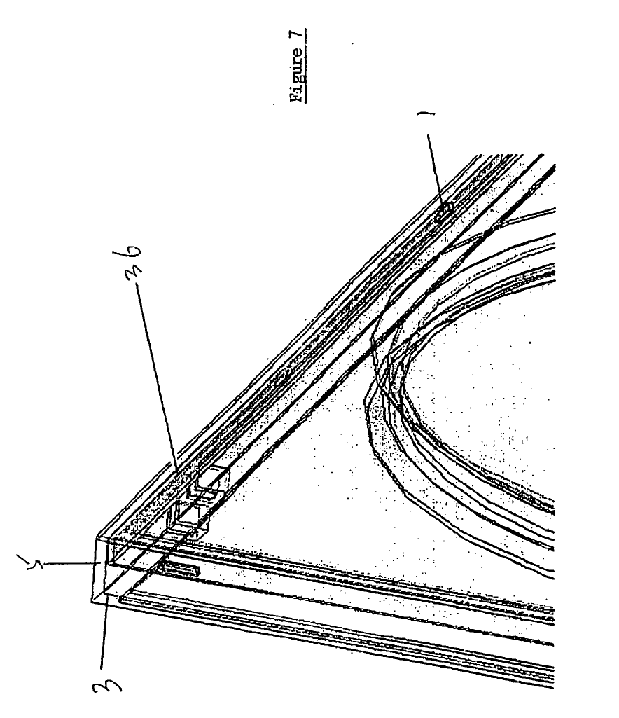

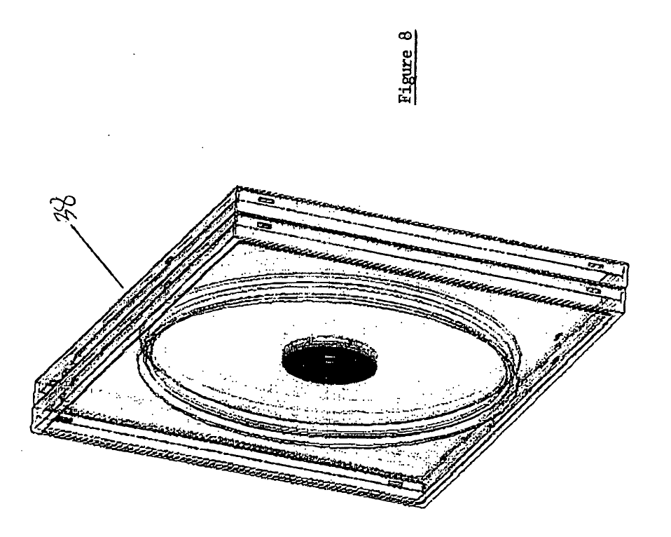

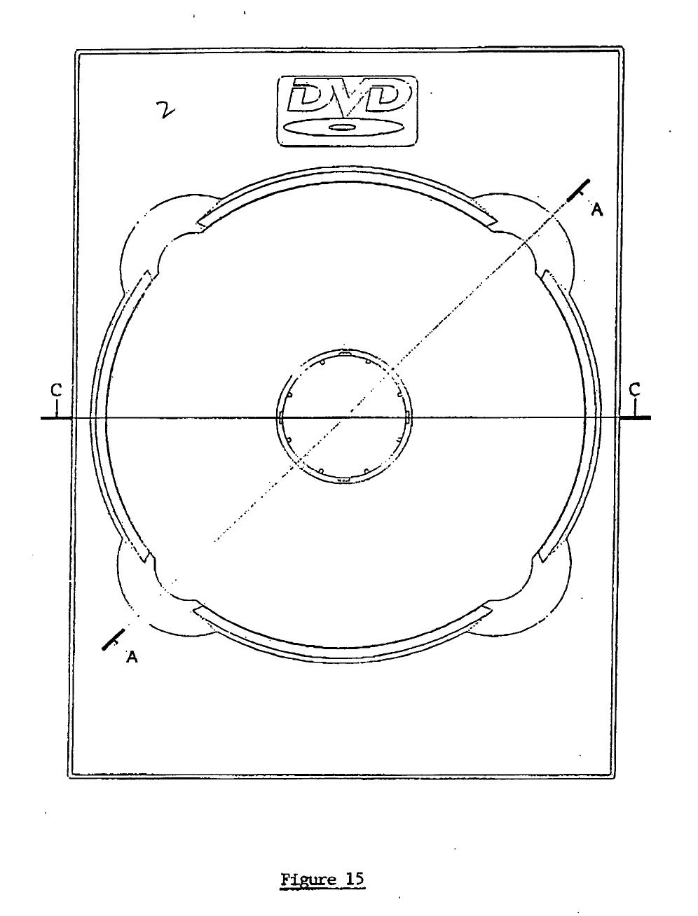

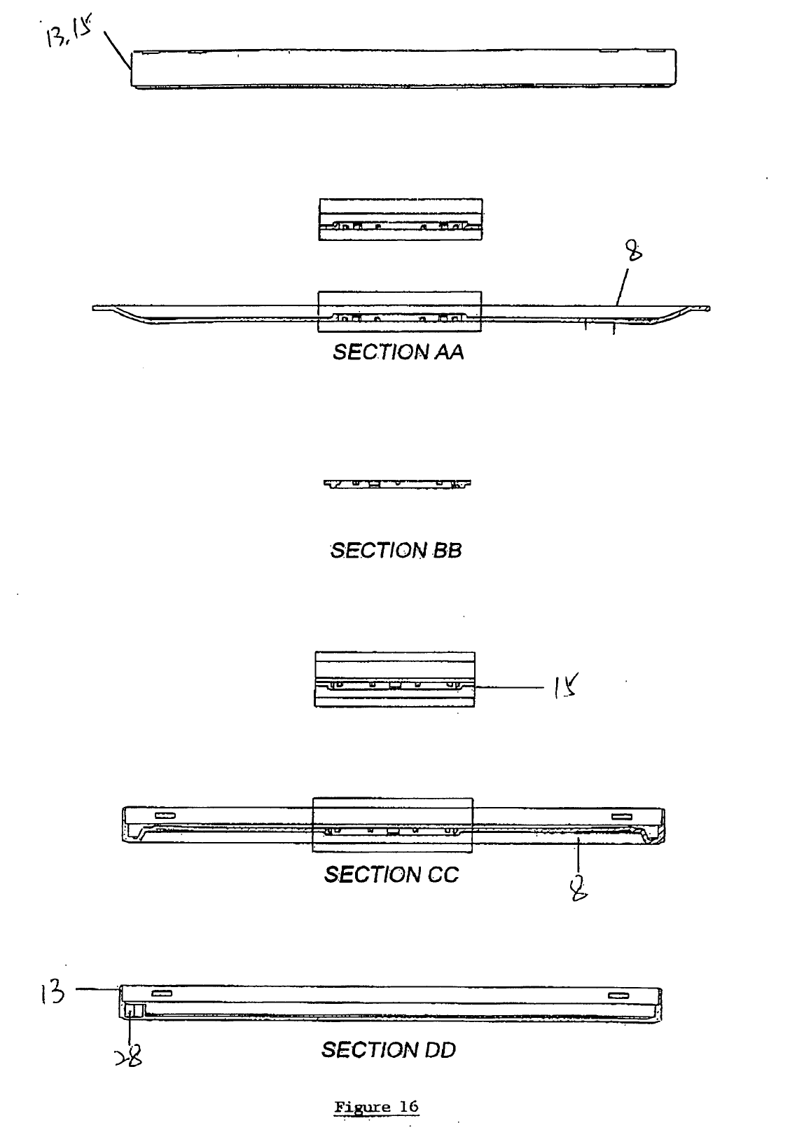

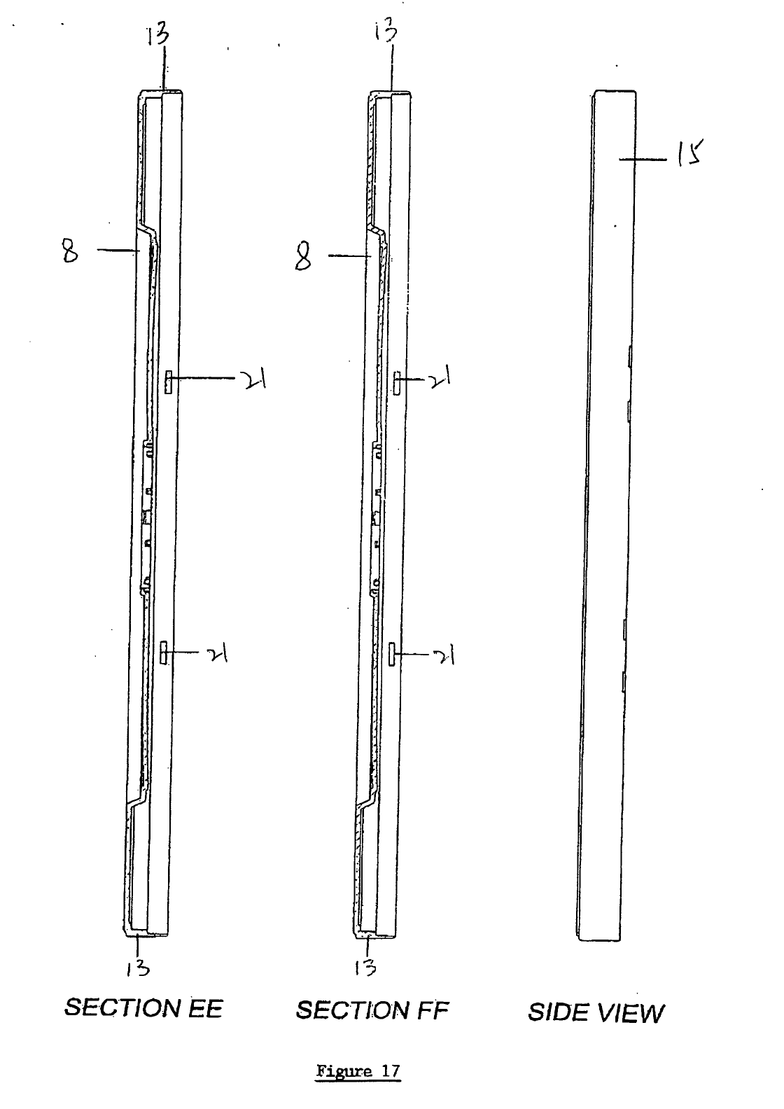

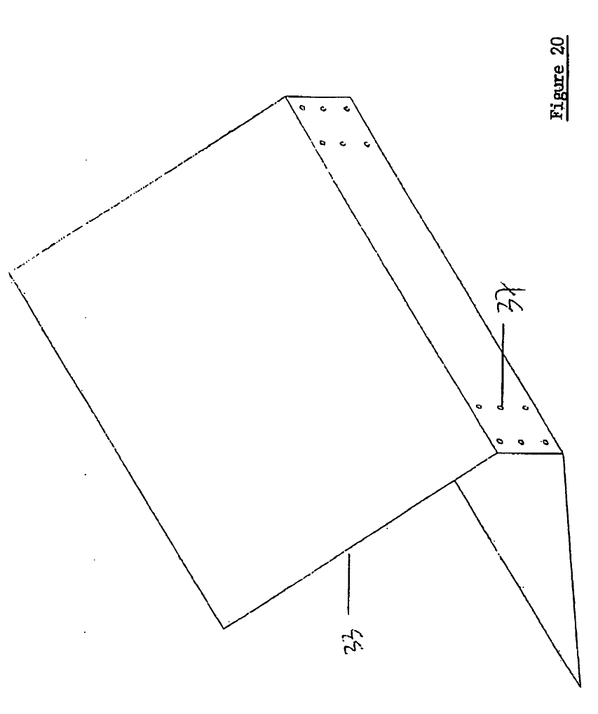

Preferred embodiments of the present invention are shown in FIGS. 1 through 23.

Recorded or recordable media storage discs include CDs (compact discs), VCD (video compact disc), DVD (digital versatile disc) and the like.

FIG. 1 shows a double face tray of the invention. The double face tray 1 comprises an assembly of a first tray 3 and a second tray 5. The first tray 3 and second tray 5 each have on their first sides 4 provision for retaining a media storage disc (a first provision 9A on the first tray 3 and a second provision 9B on the underside of the second tray 5 (not shown).

First tray 3 comprises a substantially planar face on a first major side 4 on which is provided a means 9A for retaining a media storage disc. In the preferred embodiment the disc retaining means 9A is a rosette. In other embodiments however the first provision may be integral with the first tray 3.

The rosette member is normally of a flexible kind so that it can be moved to assume a position where the disc can be released. The rosette however normally is in a retaining condition so that when a disc is engaged with the rosette the rosette will securely retain the disc and prevent the disc from moving off the rosette.

The rosette in the preferred form of the invention is provided substantially centrally on the base 4 and in a manner so that when it is retaining a disc it holds the disc substantially parallel to the base 4 and when the box is closed, also parallel to the lid. The rosette will support a disc on a platform raised above the major surface of the base so that the recorded region of the disc is held in a manner so that it does not touch any part of the box.

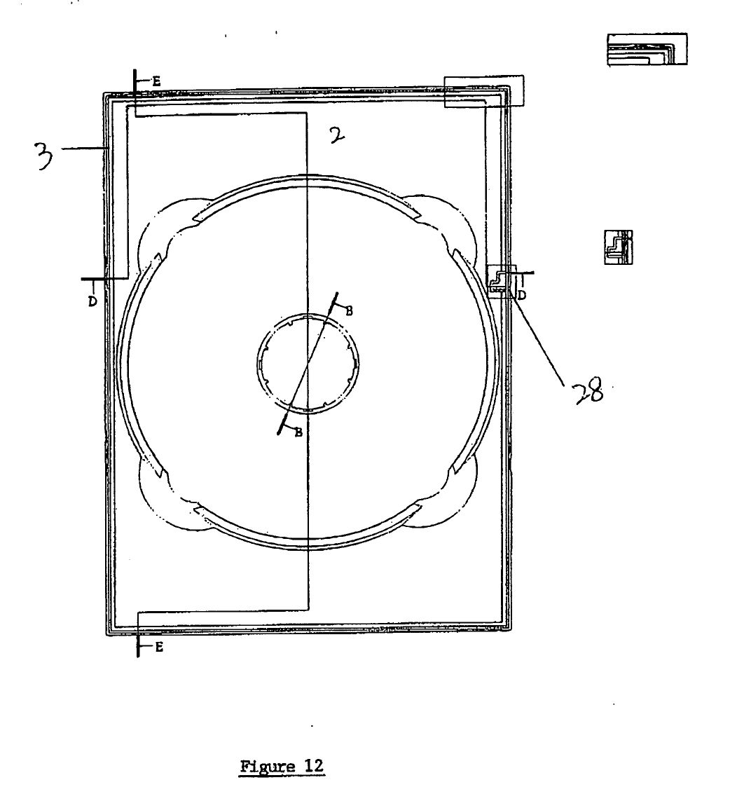

The rosette member will engage at the perimeter of the central aperture of a disc and will also extend through the aperture and may for example include a catch or lip feature which will engage with part of the upwardly facing surface (the surface facing away from the base) of the disc. The catch or lip will locate on top of the disc and prevent it from moving axially off the rosette. The rosette may for example be a push release like rosette where a person pushing down (towards the base) on the rosette will then release the disc there from. The trays may further include finger apertures 10 (shown in FIG. 11) arrayed around the periphery of the disc, into the outer surface 4 to allow access and removal of the disc easily from the recess 6.

Second tray 5 includes a similar first major surface to that of first tray 3.

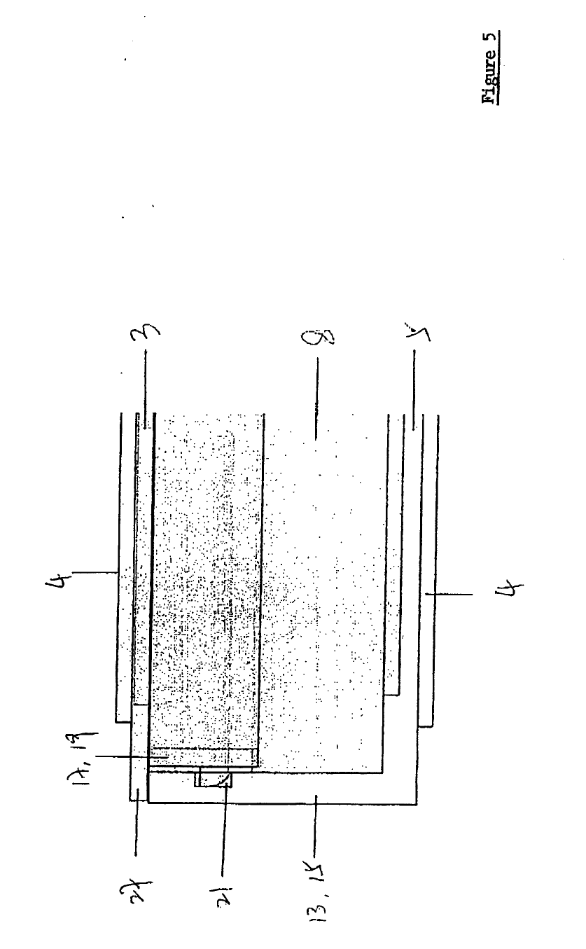

Shoulders 17 extend substantially about the periphery of first tray 3 away from the first side 4 to form a first tray skirt 19 as shown in FIG. 5. The shoulders impart rigidity to the first tray 3 and also provide location for engagement with the second tray 5. In preferred embodiments the skirt extends approximately the same depth as that of the first disc receiving recess. In alternative embodiments the skirt may extend beyond the depth of the disc receiving recess.

On the outer sides of the first tray skirt there are provided means to engage with complementary means on the corresponding second tray skirt. In the preferred embodiment the first tray skirt has protrusions 23 to engage with complementary detents in the second tray skirt.

in the preferred embodiment the first tray shoulders 17 that define the first tray skirt 19, are set in from the periphery of the outer surface 4 of the first tray 3 to define a lip 27. When assembled with the second tray 5 the lip 27 sits flush with the top edge of second tray 5 to present a smooth side and also to act as a stop for the first tray 3 when engaged with second tray 5. In other embodiments lip 27 need not be present and the outer surface 4 of the first tray 3 may sit flush with the edges of the second tray skirt 15 (defined below). In such an embodiment the first tray skirt 17 may act as the stop against the inner surface 2 of the second tray 5.

Referring back to FIG. 1 the second tray 5 is of a similar construction to that of the first tray 3, having a second disc receiving recess 6 set into the outer surface 4 of the second tray. A second provision for retaining 9B (not shown) a disc 11 is also present in the recess 6. Finger apertures may be provided about recess 6 to allow easy removal of the disc from the second tray as shown in FIG. 15.

As shown in FIG. 5 second tray 5 includes second tray shoulders 13 that extend about the periphery of the second tray 5 outer surface 4 and which depend away from the outer surface 4. These define a second tray skirt 15. In contrast to the skirt of the first tray however the skirt of the second tray does not form a lip.

The second tray skirt 15 extends sufficiently from second tray 5 to define a recess 8 between the outer surfaces of the first and second trays. Recess 8 defined by second tray skirt 15 allows for the media storage disc recess in the first and second trays. On the inner presenting surfaces of the second tray skirt 15 there are means 21 to engage with the first tray skirt 19. In the preferred embodiment these are detents 21 adapted to engage with the protrusions 23 on the first tray skirt 19. In the embodiment shown these complementary engagement means are located at or near each corner of the first tray 3 and second tray 5, making for eight such engagements for each assembled double face tray 1. In alternative embodiments a different number of complementary engagement means may be provided.

In other embodiments the arrangement of the engagement means may be altered so that the protrusions are provided on the second tray skirt and the detents are provided on the first tray skirt. In yet further embodiments alternate engagement means may be present, such as a groove and tongue, friction or other means known in the art for connecting items that exist in an overlapping state, as indicated in FIG. 5.

An inset card 11 may be provided as part of the double face tray. The inset card may contain information. The inset card may be of any size that fits in the recess. The inset card may be a booklet or any material suitable for carrying printed matter.

The first and second trays may be partially or wholly transparent.

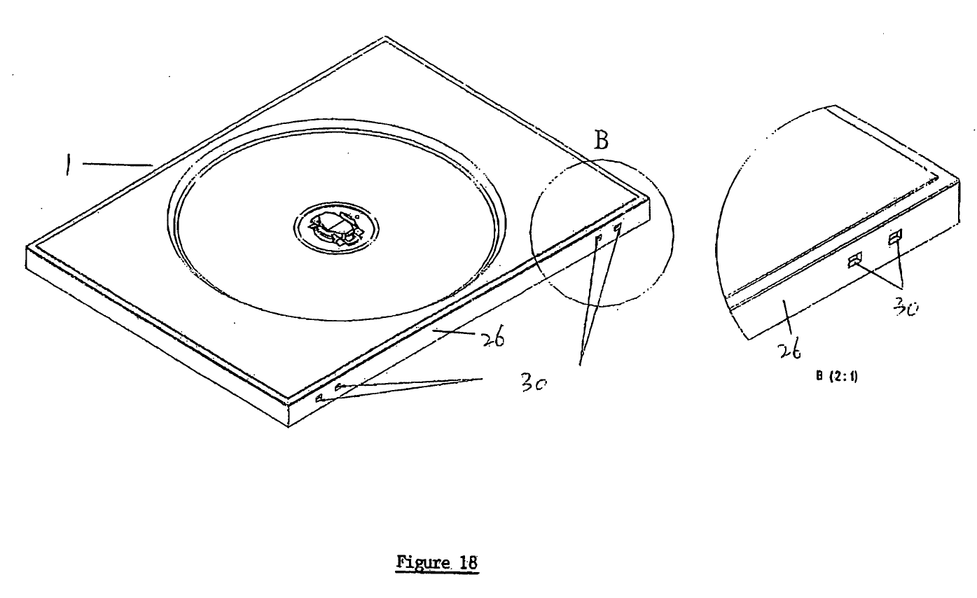

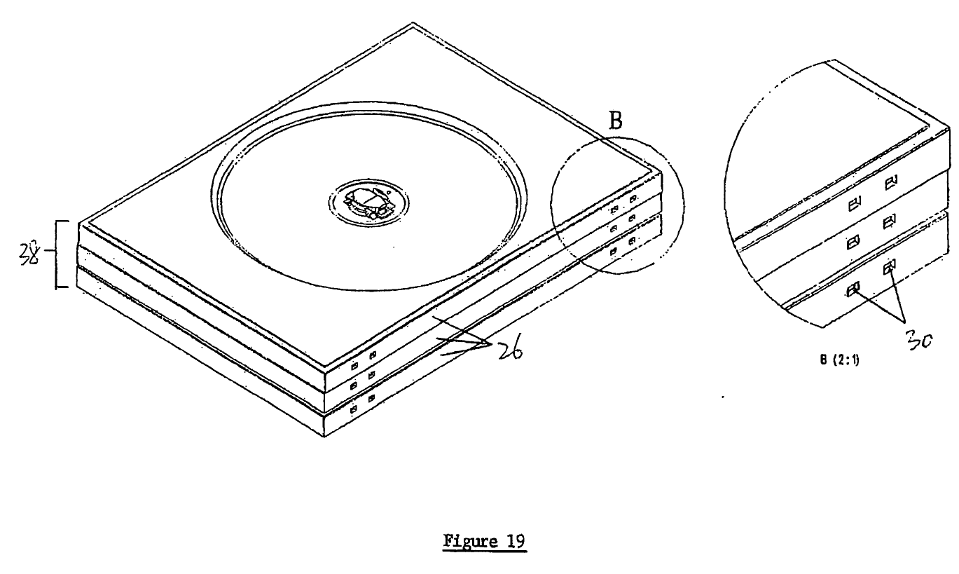

A double face tray, formed by engaging a first and second tray, may also include apertures 30 along the vertex 26 of the assembly for retaining a cover as shown in FIG. 18. The apertures allow a cover to be placed around the tray assembly and secured by a hinge means which slots through the cover and into the aperture.

The cover may be formed from any suitable material but will typically be formed from plastics, cardboard or paper or a combination of plastics and paper.

In alternative embodiments the cover may be attached to a tray assembly or tray assemblies by use of adhesives or glues.

An array of double face tray assemblies can be formed by arranging a plurality of double face trays and the use of one or more flexible spine hinges 31 and optionally a cover as shown in FIGS. 19 to 22. The flexible spine hinge has a hinging means 36 aligned with a common vertex 29 of two co-located double face trays 1. Two hinging means 36 are preferably provided for each array one at each end of the vertex 5.

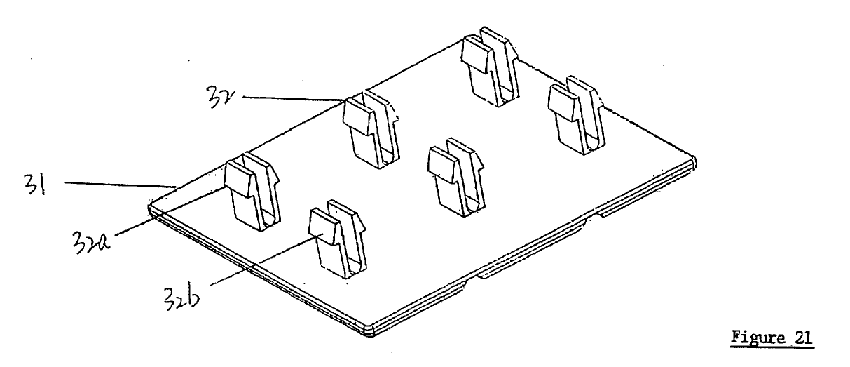

The flexible spine hinges have in the preferred embodiment a plurality of brackets 32, which engage with and are retained securely by receiving apertures 30 in each of the tray assembly spines 26. The hinge shown in FIG. 21 is adapted to connect three tray assemblies together with brackets 32a and 32b retained in the first assembly spine etc. Different numbers of tray assemblies can be connected together by extending or reducing the number of brackets or pairs of brackets on the flexible spine hinge.

If a cover 33 is required for a double face storage tray of an array of double faced storage trays then this can be located between the flexible spine hinge 31 and the assembled trays, by the cover engaging and being retained by the brackets 32. Such engagement is facilitated by cover holes 37 through which the brackets 32 pass before engaging with the apertures in the tray. Alternatively the cover may be attached to the tray(s) using adhesives or glue.

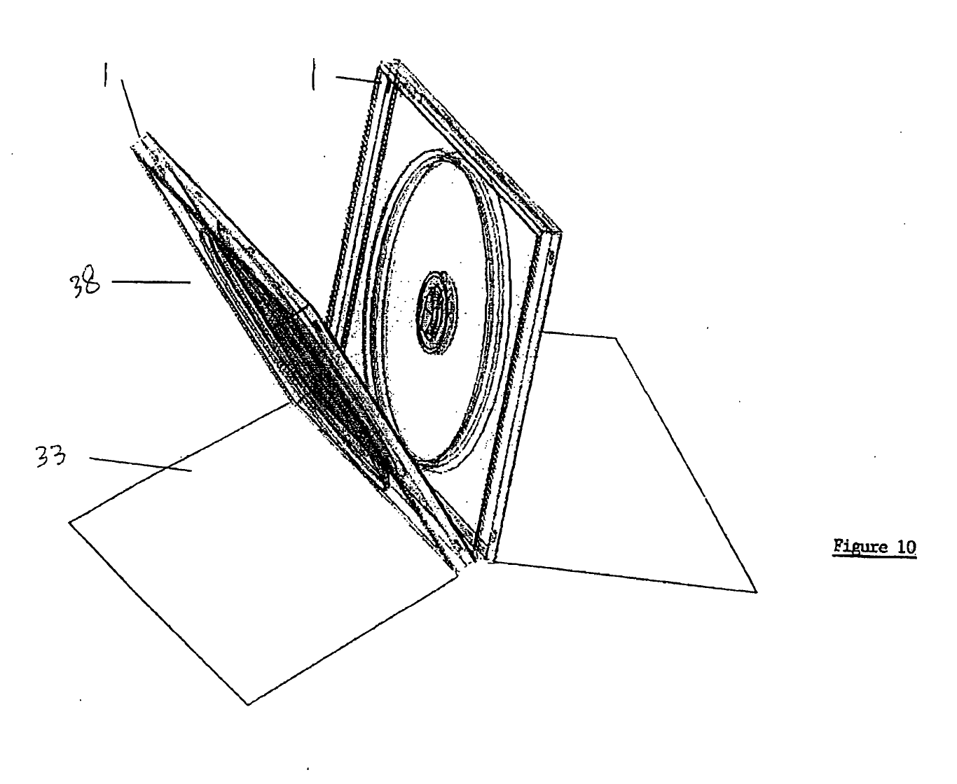

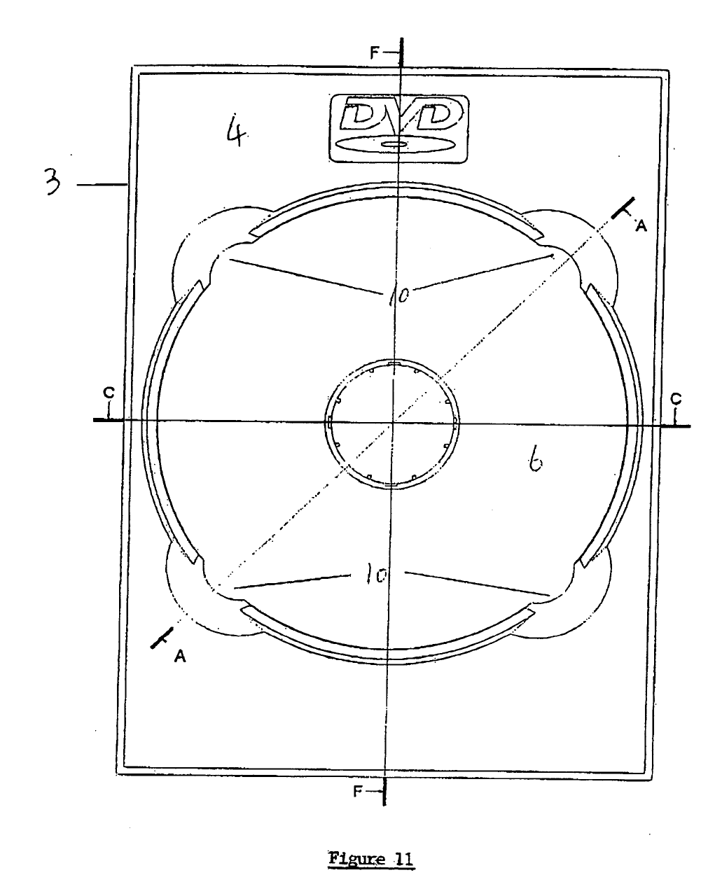

FIG. 10 shows an array of two assemblies connected by two hinges (not shown) and a cover 33. As can be seen in FIG. 10 the hinge allows the double face trays to rotate to provide access to all discs stored on the trays. Each double face tray can further be opened to access information that can be stored inside the double face tray.

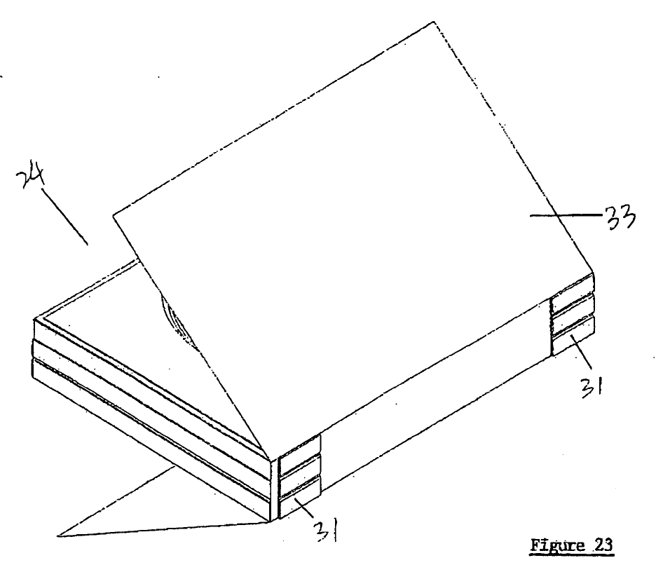

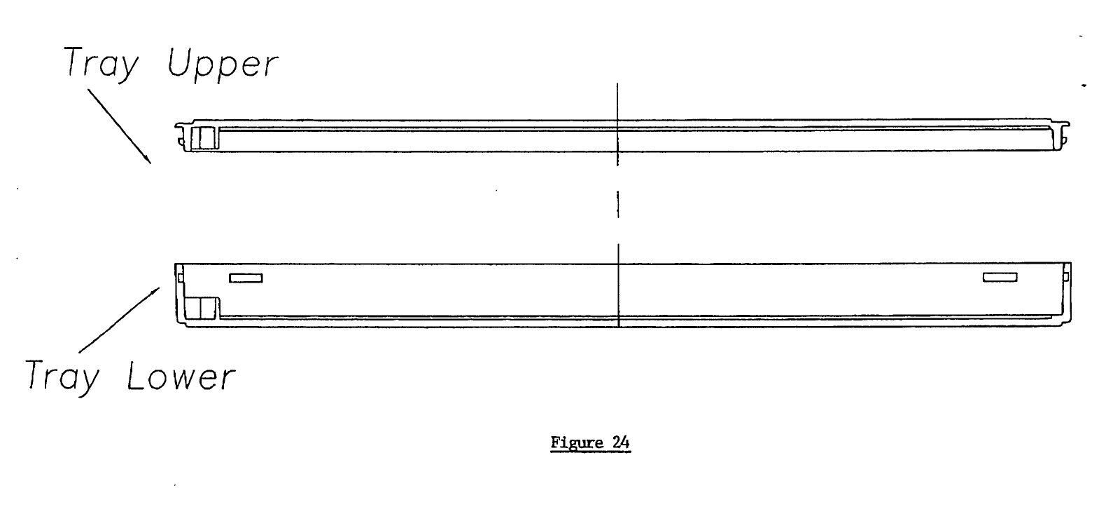

FIG. 23 shows an array of three double face trays connected by two hinges 31 and a cover 33. The hinges in this embodiment are the same as those shown in FIG. 21.

In use prior to engaging the first and second trays an insert card 11, containing visual and/or written information is located between the first tray 3 and the second tray 5 as shown in FIGS. 1 and 3. The skirt of second tray 5 allows the insert card to be laid in the second tray.

The insert card 11 is then captured and retained between the two trays when the trays are engaged and assembled—into a double face tray. In one embodiment the trays are formed from transparent material, preferably transparent plastics. In this embodiment due to the transparent nature of the material from which the first and second trays are formed the information presented on the insert card 11 is clearly visible thought the first tray 3 and the second tray 5. In other embodiments only one tray or part thereof may be transparent if required. In yet other embodiments the trays may be formed from opaque material.

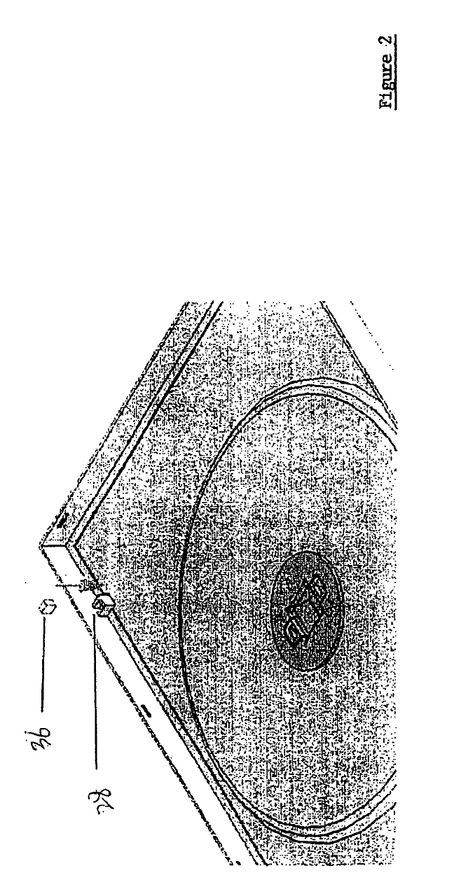

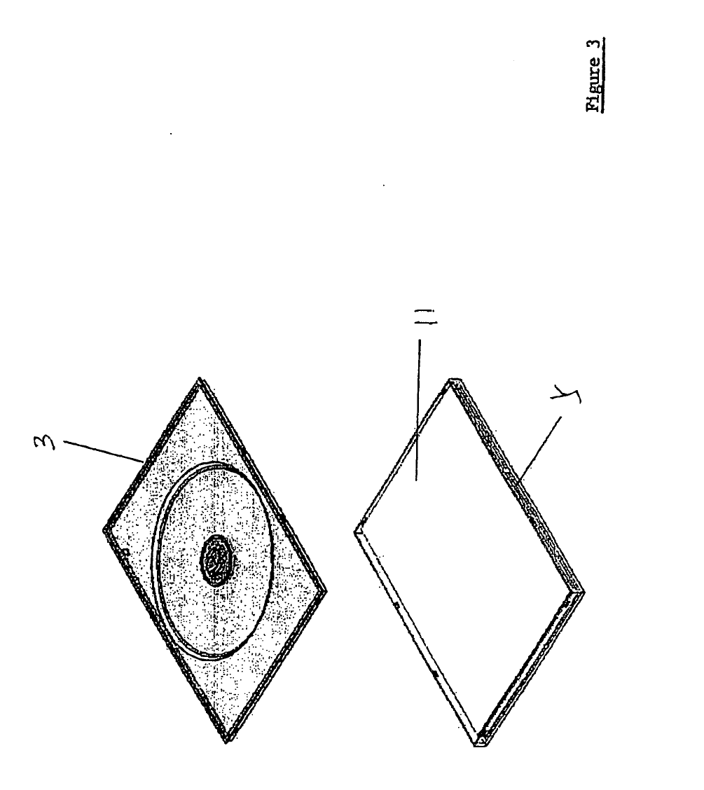

Referring now to FIG. 2, each of said first tray 3 and said second tray 5 may further comprise retention means 28 for receiving magnet 36. The retention means are, in the preferred embodiment, disposed to the inner surfaces 2 of one or both trays and positioned to align when the first and second trays are engaged.

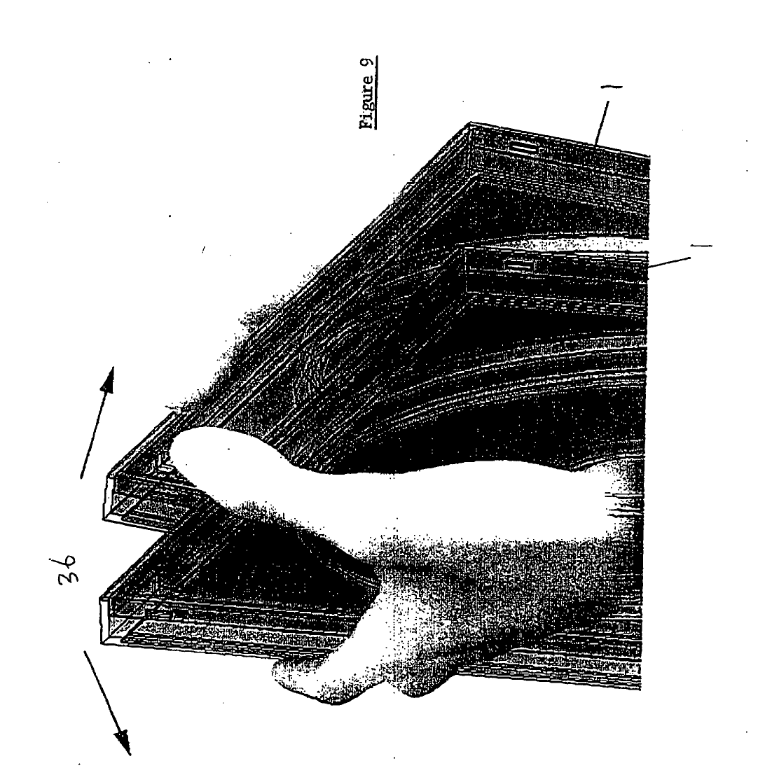

In embodiments including magnets, the magnets are provided in only one of the first and second trays in an assembly when two or more double faced trays are assembled together the magnets 36 in one double faced tray assembly, when correctly pole oriented, attract the magnets in the other double faced tray assembly. When brought close enough together these assemblies are thus retained in a closed position, which magnetic attraction can, if required, be broken to open the array of assemblies to access or return the discs inside the assemblies (as shown in FIG. 9). In alternative embodiments magnets are provided in both the first and second trays.

The first tray 3 and second tray 5 are assembled into a double face tray 1 by bringing the two together (optionally with an insert card 11 therebetween) and locating the first tray skirt 19 inside the second tray skirt 15 and pressing the two together until the detents 21 and protrusions 23 engage and retain the first tray 3 to the second tray 5.

In preferred embodiments at least part of at least one tray is transparent and allows information on insert 11 to be viewed through the tray. In these preferred embodiments the first and second trays cannot be easily disengaged after engagement.

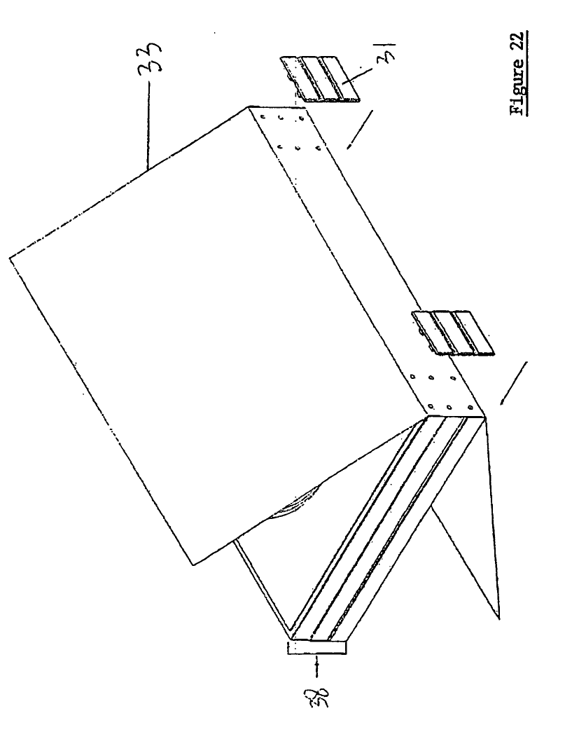

If two or more tray assemblies are to be provided in an array these can be connected together with a hinge. In the embodiment shown in FIG. 22 three assemblies are connected together in an array 38 using cover 33 and hinges 31. It should be noted that the array can be formed with the use of the hinges only and the cover is not essential. In a further embodiment hinge 31 may comprise three separate hinges, one for each assembly, in which embodiment the cover is essential to form the array.

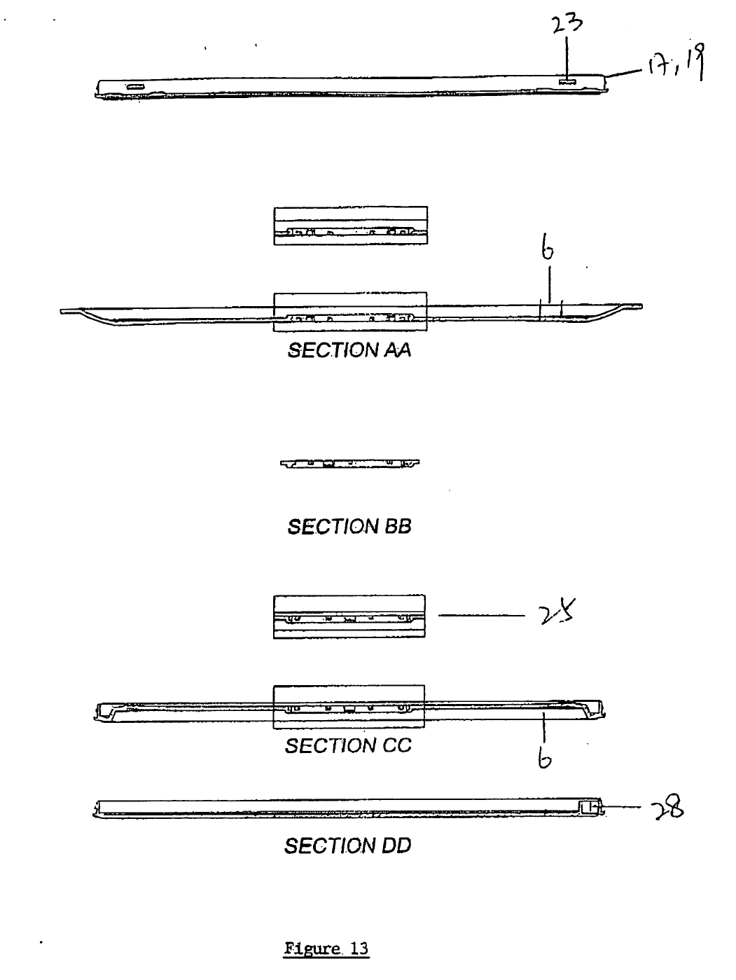

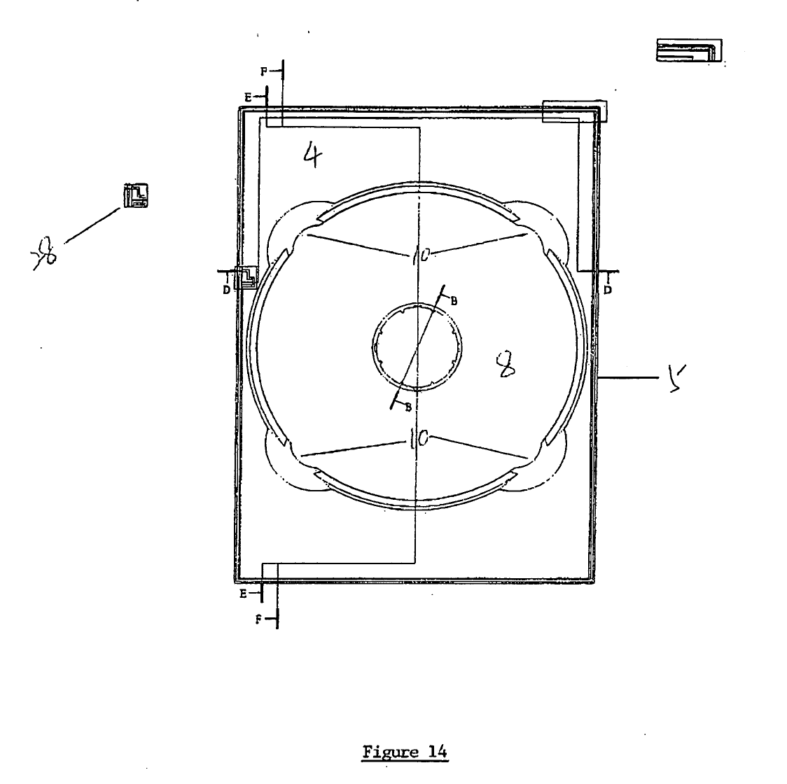

An advantage of the present invention is that it can be used to provide a slim double sided storage tray. As can be seen in FIGS. 13, 16 and 17 the depth of each tray may be substantially only that needed to provide for the storage discs. This leaves a small recess between the trays for an insert card as defined by the tray skirts. The depth of a double sided storage tray can be defined by the depth of the skirts to any depth equal or greater than that required by the storage discs.

The foregoing describes the invention including preferred forms thereof. Alterations and modifications as will be obvious to those skilled in the art are intended to be incorporated in the scope hereof as defined by the accompanying claims.

1. A double sided disc storage tray comprising
a first tray including a first and a second major side which are parallel to each other, the first major side including a media storage disc fastening means to releasably retain a media storage disc and including engagement means to engage with a complementary engagement means on a second tray,
a second tray including a first and a second major side which are parallel to each other, the first major side including a media storage disc fastening means to releasably retain a media storage disc and including engagement means to engage with a complementary engagement means on a first tray,
the first and second trays engaged by the complementary engagement means so that the second sides of each tray are adjacent and the first sides of each tray form the outer surface of the double sided disc storage tray.

2. A double sided disc storage tray as claimed in claim 1 further comprising an insert card containing information inserted and captured between the second sides of the first and second trays.

3. A double sided disc storage tray as claimed in claim 2 wherein a part of each said tray is transparent to allow the insert to be viewed.

4. A double sided disc storage tray as claimed in claim 2 wherein each tray is transparent to allow the insert to be viewed.

5. A double sided disc storage tray as claimed in claim 1 wherein said second tray is substantially planar with a skirt formed by shoulders about the tray periphery, depending away from the first side of the tray.

6. A double sided disc storage tray as claimed in claim 5 wherein said first tray is substantially planar with a skirt formed by shoulders about the first tray periphery, depending away from the first side of the tray.

7. A double sided disc storage tray as claimed in claim 6 wherein the first tray skirt engages with the second tray skirt.

8. A double sided disc storage tray as claimed in claimed 7 wherein the first and second tray engagement is via complementary detents in one tray skirt, and protrusions in the other tray skirt.

9. A double sided disc storage tray as claimed in claim 8 wherein the second tray skirt includes said detents and the first tray skirt includes said protrusions.

10. A double sided disc storage tray as claimed in claim 7 wherein the first tray includes at least one second shoulder depending from said tray, outside of the first tray skirt that sits flush with the outer surfaces of the second tray skirt when the first and second trays are engaged.

11. A double sided disc storage tray as claimed in claim 1 wherein the first tray or second tray includes on a vertex thereof provision for engaging a hinge to join two or more double sided disc storage trays into an array.

12. A double sided disc storage tray as claimed in claim 11 further including a flexible spine hinge comprising a back plate and a plurality of brackets.

13. A double sided disc storage tray as claimed in claim 12 further including a cover comprising a front face substantially the same size as a major side of a tray, a spine and a back face substantially the same size as a major side of a tray.

14. A double sided disc storage tray as claimed in claim 13 wherein said flexible spine hinge retains the cover between the flexible spine hinge and the vertex of the storage tray.

15. A double sided disc storage tray as claimed in claim 11 wherein the first or second tray includes two pairs of receiving apertures for locating and engaging with the flexible spine hinge.

16. An array of double sided disc storage trays comprising
a plurality of first trays, each including a first and a second major side which are parallel to each other, the first major side including a media storage disc fastening means to releasably retain a media storage disc and including engagement means to engage with a complementary engagement means on a second tray,
a plurality of second trays, each including a first and a second major side which are parallel to each other, the first major side including a media storage disc fastening means to releasably retain a media storage disc and including engagement means to engage with a complementary engagement means on a first tray,
each first tray engaged to a second tray by the complementary engagement means so that the second sides of each tray are adjacent and the first sides of each tray form the outer surface of the double sided disc storage tray,
and arranging the double sided storage trays to form an array of double sided disc storage trays.

17. An array of double sided disc storage trays as claimed in claim 16 further comprising insert cards containing information inserted and captured between the second sides of the first and second trays.

18. An array of double sided disc storage trays as claimed in claim 17 wherein a part of each said tray is transparent to allow the insert to be viewed.

19. An array of double sided disc storage trays as claimed in claim 17 wherein each tray is transparent to allow the insert to be viewed.

20. An array of double sided disc storage trays as claimed in claim 16 wherein each second tray is substantially planar with a skirt formed by shoulders about the tray periphery, depending away from the first side of the trays.

21. An array of double sided disc storage trays as claimed in claim 20 wherein each first tray is substantially planar with a skirt formed by shoulders about the first tray periphery, depending away from the first side of the trays.

22. An array of double sided disc storage trays as claimed in claim 21 wherein each first tray skirt engages with a second tray skirt.

23. An array of double sided disc storage trays as claimed in claimed 22 wherein the first and second tray engagements are via complementary detents in one tray skirt, and protrusions in the other tray skirt.

24. An array of double sided disc storage trays as claimed in claim 23 wherein each second tray skirt includes said detents and each first tray skirt includes said protrusions.

25. An array of double sided disc storage trays as claimed in claim 22 wherein each first tray includes at least one second shoulder depending from said trays, outside of the first tray skirt that sits flush with the outer surfaces of a second tray skirt when the first and second trays are engaged.

26. An array of double sided disc storage trays as claimed in claim 16 wherein each first tray or each second tray includes on a vertex thereof provision for engaging a hinge to join two or more double sided disc storage trays into an array.

27. An array of double sided disc storage trays as claimed in claim 26 further including at least one flexible spine hinge comprising a back plate and a plurality of brackets.

28. An array of double sided disc storage trays as claimed in claim 27 further including a cover comprising a front face substantially the same size as a major side of a tray, a spine and a back face substantially the same size as a major side of a tray.

29. An array of double sided disc storage trays as claimed in claim 28 wherein said flexible spine hinges retain the cover between the flexible spine hinge and the vertex of the storage tray.

30. An array of double sided disc storage trays as claimed in claim 26 wherein each first or second tray includes two pairs of receiving apertures for locating and engaging with the at least one flexible spine hinge.

31. An array of double sided disc storage trays as claimed in claim 27 wherein two of more double sided disc storage trays are retained in a closed form about said at least one flexible spine hinge.

32. An array of double sided disc storage trays as claimed in claim 16 wherein one of each of the first and second storage trays include at least one magnet, said magnets aligned so as to attract each other and retain the double sided storage trays in an array.

33. An array of double sided disc storage trays as claimed in claim 16 wherein all the storage trays include at least one magnet, said magnets aligned so as to attract each other and retain the double sided storage trays in an array.

34. An array of double sided disc storage trays as claimed in claim 32 further including a flexible spine hinge comprising a back plate and a plurality of brackets, and a cover comprising a front face substantially the same size as a major side of a tray, a spine and a back face substantially the same size as a major side of a tray, wherein the flexible spine hinge retains the cover between the flexible spine hinge and the vertexes of the array of double sided disc storage trays.
